(19) United States
(12) Patent Application Publication
(10) Pub. No.: US 2021/0285805 A1
(43) Pub. Date: Sep. 16, 2021

(54) METHOD FOR OPERATING A CORIOLIS MEASURING DEVICE, AND CORIOLIS MEASURING DEVICE

(71) Applicant: Endress+Hauser Flowtec AG, Reinach (CH)

(72) Inventor: Hao Zhu, Freising (DE)

(21) Appl. No.: 17/254,672

(22) PCT Filed: May 10, 2019
(86) PCT No.: PCT/EP2019/062103

§ 371 Date: Dec. 21, 2020

(30) Foreign Application Priority Data
Jun. 20, 2018 (DE) 10 2018 114 796.1

(51) Int. Cl. G01F 1/84

(52) U.S. Cl. CPC G01F 1/8472; G01F 1/8431; G01F 1/8427; G01F 1/8422

(57) ABSTRACT

The invention relates to a method for operating a Coriolis measuring device where at least two sensors register measuring tube oscillations excited by at least one exciter. The sensors are arranged one after another along a measuring tube centerline, wherein a first sensor registers a first, inlet side, oscillation characteristic of the measuring tube oscillation, and a second sensor registers at least a second, outlet side, oscillation characteristic of the measuring tube oscillation. A local concentration fluctuation or incidence fluctuation of an additional component influences the measuring tube oscillation in a region of the local concentration fluctuation or incidence fluctuation. In a first method step shifting the local concentration fluctuation or incidence fluctuation is registered using at least two sensors. In a second method step a velocity of the second component is calculated based on the registered shifting of the local concentration fluctuation or incidence fluctuation.

The invention relates to a method for operating a Coriolis measuring device for measuring mass flow and/or flow velocity of a medium flowing through at least one measuring tube and containing at least two non-mixable components.

Coriolis measuring devices, such as, for example, described in WO2006010687A1, are suited for measuring mass flow as well as density of a medium flowing through at least one measuring tube of the measuring device.

For the case of a medium, which is composed of a single substance or has exclusively a plurality of substances mixable with one another, such a measuring device delivers exact results.

However, there are different fields of use, in the case of which this proviso is not met. For example, in the case of processing milk, a medium can be present, which is mainly liquid but also contains gaseous and/or solid components. In case these additional components are present in low concentrations and are not homogeneously distributed, this inhomogeneity can make a flow- or density measurement difficult.

An object of the invention is, consequently, to provide a method for operating a Coriolis measuring device and a Coriolis measuring device, which avoid the above described problems.

The object is achieved by a method as defined in independent claim 1 as well as by an apparatus as defined in independent claim 10.

In the method of the invention for operating a Coriolis measuring device for measuring mass flow and/or flow velocity of a medium flowing through at least one measuring tube containing at least two non-mixable components,

each measuring tube has an inlet and an outlet,

at least two sensors register measuring tube oscillations excited by at least one exciter,

the sensors are arranged one after another along a measuring tube centerline, wherein a first sensor registers a first, inlet side, oscillation characteristic of the measuring tube oscillation at a first sensor posititon, and wherein a second sensor registers a second, outlet side, oscillation characteristic of the measuring tube oscillation at a second sensor position, a local concentration fluctuation or incidence fluctuation of at least one additional component, thus, firstly, a second component, influences the measuring tube oscillation in a region of the local concentration fluctuation or incidence fluctuation,

the influencing leads to a variation of an amplitude and/or a phase of the measuring tube oscillation,

wherein in a first method step a shifting of the local concentration fluctuation or incidence fluctuation is registered by means of the at least two sensors,

wherein in a second method step a velocity of the second component is calculated based on the registered shifting of the local concentration fluctuation or incidence fluctuation.

Usable oscillation characteristics in such case, are, for example, an oscillation amplitude or an oscillation phase or an oscillation frequency. Metrologically, the ascertaining of an oscillation amplitude, oscillation phase or oscillation frequency can occur, for example, by registering a sensor signal as a function of time and subsequent signal evaluation. Usually, an oscillation sensor of a Coriolis measuring device includes a permanent magnet apparatus and a coil apparatus, which are moved by the oscillations relative to one another, whereby a measurable electrical voltage, thus a voltage evaluatable by an electronic measuring/operating circuit, is induced in the coil. For example, the oscillation characteristic can be a phase of an oscillation sensor or a phase difference between two oscillation sensors. The variable followed as a function of time can, however, also be a variable derived from the sensor signal, such as, for example, a mass flow.

In an embodiment, a first function of time of the first oscillation characteristic is compared with a second function of time of the second oscillation characteristic,

wherein a time offset occurrence of a variation of the first function of time relative to a variation of the second function of time is taken to mean the presence of a local concentration fluctuation or incidence fluctuation of the second component,

wherein the velocity of the second component is calculated based on the time offset of the occurrence of the variations.

The velocity of the second component can, for example, be taken into consideration for a plausibility check of a mass flow measured by means of the Coriolis effect.

In order that a time offset of the variations can be detected as caused by a concentration fluctuation, the time offset must be greater than the ratio of path length along the measuring tube centerline between the corresponding sensors and the velocity of sound in the medium, or in the first component. Those skilled in the art can, in such case, also use values based on experience. As soon as a time offset is less than the ratio, or less than a value based on experience, the offset can be considered to be non-existent as regards the detecting of a concentration fluctuation. Upon detecting a variation, which is, for example, superimposed on a sensor flow signal, usual techniques of signal processing, such as, for example, signal edge detection, signal filtering, such as, for example, Fourier transformation, or autocorrelation, can be applied.

In an embodiment, a third sensor registers a third oscillation characteristic of the measuring tube oscillation at a third sensor position, wherein the third sensor position is located between the first sensor position and the second sensor position,

wherein at least two of the following functions of time are compared:

the first function of time of the first oscillation characteristic, the second function of time of the second oscillation characteristic, a third function of time of the third oscillation characteristic,

wherein a time offset occurrence of a variation of a function of time relative to a variation of another function of time is taken to mean the presence of a local concentration fluctuation or incidence fluctuation of the second component,

wherein the velocity of the second component is calculated based on the time offset of the occurrence of the variations, and/or

wherein a first difference between the first oscillation characteristic and the third oscillation characteristic and a second difference between the third oscillation characteristic and the second oscillation characteristic are formed,

wherein a time offset variation of a fourth function of time of the first difference relative to a variation of a fifth function of time of the second difference is taken to mean the presence of a local concentration fluctuation or incidence fluctuation of the second component,

wherein the velocity of the second component is calculated based on the time offset of the occurrence of the variations of the differences.

With three sensors, similarly as with two sensors, in each case, an offset between two different sensors can be taken into consideration. However, also two differences of signal characteristics between two sequential sensors can be formed and, in each case, a variation of the difference can be taken into consideration for detecting a concentration fluctuation. Thus, a local concentration fluctuation leads to a variation in the case of a difference. Such can be put into practice, for example, in the context of a conventional Coriolis flow measurement between two sequential sensors, in the case of which oscillation characteristics of a measuring tube oscillation based on the Coriolis effect are registered.

In an embodiment, a comparison of the functions of time of oscillation characteristics and ascertaining the time offset of variations are based on at least one of the following:

forming a cross correlation of the functions of time,

ascertaining a position of at least one extreme value of the variations.

By cross correlation, a similarity of different functions of time can be registered and a time offset of characteristics of the functions of time can be reliably calculated.

In an embodiment, the at least one measuring tube is at least sectionally bent, wherein the first sensor position in the flow direction is before the bend or in a beginning region of the bend, and wherein the second sensor position in the flow direction is after the bend or in an end region of the bend,

wherein at least one difference between variations of different functions of time is taken into consideration, in order to determine at least one property of at least a second component,

wherein at least one of the following properties of the variations is considered:

amplitude, width, asymmetry.

The bend can lead to a centrifugal force related shift between the first component and the second component. Such a shift can in turn lead to a characteristic change of the variation of the second function of time, or third function of time, compared with the variation of the first function of time. For example, a gaseous second component in a liquid first component can be pushed toward the inside of the bend. In this way, for example, information concerning the viscosity of the first component or concerning a ratio, Stokes number to viscosity of the first component, can be gained.

In an embodiment, the first component is liquid, wherein the second component is liquid, solid or gaseous.

In an embodiment, the first component is a mixture of mixable substances, and/or

wherein the second component is a mixture of mixable substances.

In an embodiment, in a third method step, a velocity of the first component is ascertained from the velocity of the second component,

wherein at least one of the following variables is taken into consideration for ascertaining the velocity of the first component:

angle of inclination of the at least one measuring tube relative to the force of gravity,

viscosity of the first component,

mass density of the first component and/or the second component,

Stokes number,

characteristic diameter of the second component in the first component.

In ascertaining the flow velocity of the first component, the flow properties of the second component in the first component can be taken into consideration. Thus, in the case of an inclined measuring tube, a gaseous second component in a liquid first component can, as a result of upwardly directed forces, have a different velocity relative to the measuring tube than the first component. Such is, for example, relevant in the case of lower viscosity of the first component. Another relevant variable, which can be taken into consideration, is the Stokes number, especially in connection with a viscosity of the first component, wherein the Stokes number expresses the meaning of the inertia of a second media component in the first media component. Alternatively, also a characteristic diameter of an accumulation of the second component can be taken into consideration as a substitute for the Stokes number.

In an embodiment, a mass flow of the medium is determined by means of a mass density as well as the velocity of the first component and/or a mass density of the second component as well as the velocity of the second component.

A Coriolis measuring device of the invention comprises:

At least one measuring tube for conveying a medium;

at least one exciter, which is adapted to excite the measuring tube to execute oscillations;

at least two sensors, which are adapted to register the oscillations of the measuring tube;

an electronic measuring/operating circuit, which is adapted to operate the exciter as well as the sensors and to determine and to output mass flow-, or flow velocity-, or density measurement values, as well as to perform the method of the invention;

wherein the measuring device includes especially an electronics housing for housing the electronic measuring/operating circuit.

In an embodiment, the measuring device includes at the inlet as well as at the outlet of the at least one measuring tube, in each case, a securement apparatus, which is adapted, in each case, to define the position of an outer oscillatory node,

wherein the securement apparatus includes, for example, at least one plate, which plate at least partially surrounds at least one measuring tube.

The invention will now be described based on examples of embodiments presented in the appended drawing, the figures of which show as follows:

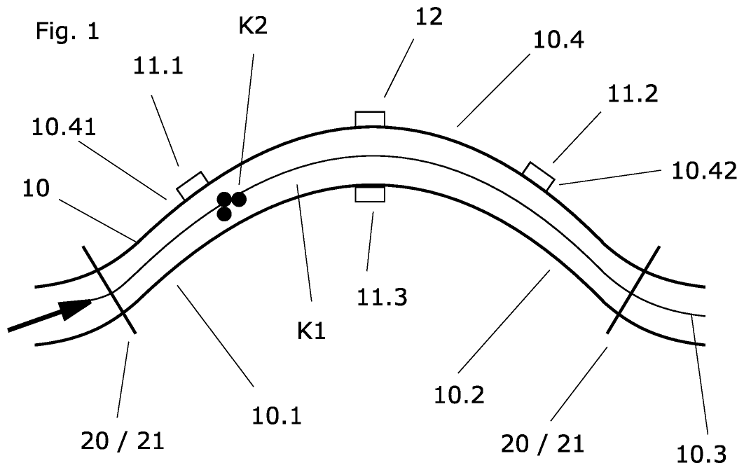

FIG. 1 by way of example, an arrangement according to the invention of sensors and an exciter on a measuring tube.

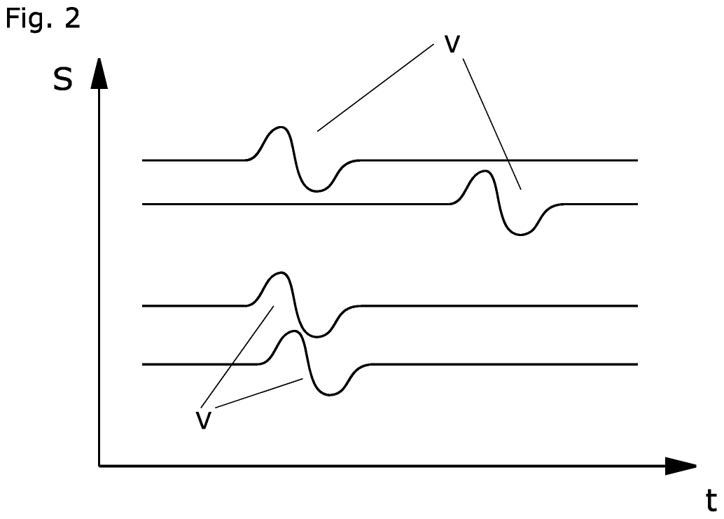

FIG. 2 by way of example, sensor signals.

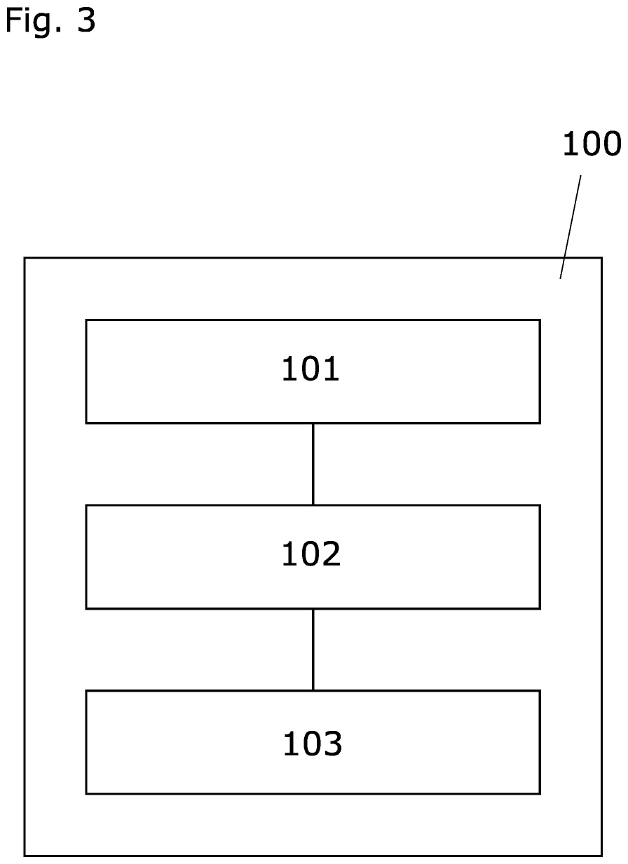

FIG. 3 a process flow of the invention.

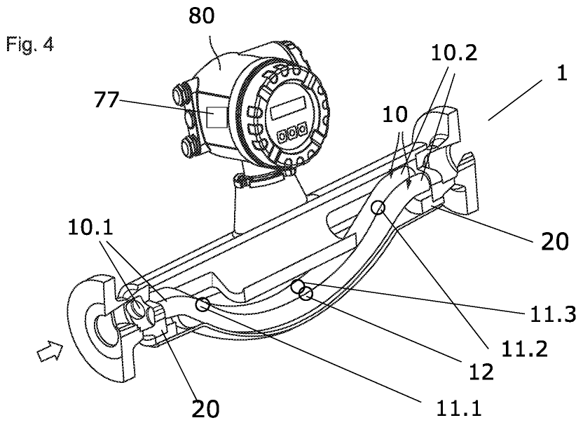

FIG. 4 by way of example, a Coriolis measuring device of the invention.

FIG. 1 shows by way of example a sensor-, exciter arrangement of the invention on a measuring tube 10 of a Coriolis measuring device. Thus, a first sensor 11.1 is arranged on an inlet side 10.1 of the measuring tube 10, a second sensor 11.2 is arranged on an outlet side 10.2 of the measuring tube 10 and a third sensor 10.3 is centrally arranged on the measuring tube 10. The measuring tube is excited by means of an exciter 12 to execute oscillations. Securement apparatuses 20, one at each measuring tube end, define outer oscillatory node points. A securement apparatus can comprise, in each case, a plate 21, as shown here. The medium flowing through the measuring tube includes a predominant first component K1, which carries along at least a second component K2. The second component can in the case of a sufficiently low concentration be locally unequally distributed, so that a local influencing of the oscillating measuring tube takes place. The local influencing can be utilized, in order to register a forward motion velocity of the second component by means of the sensors. A flow velocity of the first component can be supplementally derived therefrom. The arrangement of the sensors as well as of the exciter is for purposes of illustration and is not to be construed as limiting. A method of the invention can also be performed with two sensors or with more than the three sensors shown here.

The first sensor at a first sensor position is adapted to register at least a first, inlet side, oscillation characteristic of the measuring tube oscillation. The same holds for the second, outlet side sensor as well as the centrally arranged, third sensor. Oscillation characteristics, which are registered by the sensors, are, for example, amplitude, phase or oscillation frequency.

The registering of a local concentration fluctuation or incidence fluctuation can be performed in different ways. For example, an oscillation characteristic registered as a function of time with a sensor can be compared with an oscillation characteristic registered as a function of time by another sensor, wherein a time offset occurrence of a variation of a function of time relative to a variation of the other function of time is taken to indicate the presence of a local concentration fluctuation or incidence fluctuation of the second component. In the case of the presence of two sensors, thus, a first oscillation characteristic registered as a function of time by the first sensor can be compared with a second oscillation characteristic registered by the second sensor as a function of time. In the case of presence three or more sensors, thus, a third function of time and corresponding other functions of time can be registered and compared with one another.

In the case of presence of three or more sensors, however, also differences between different functions of time can be formed. A comparison of different differences in the presence of a local concentration fluctuation or incidence fluctuation of at least one additional component, thus, firstly, a second component, can correspondingly be taken into consideration for calculating a forward motion velocity of at least the second component.

The velocity of the second component is calculated based on the time offset of the occurrence of the variations. In order that a time offset of the variations caused by a concentration fluctuation is detected, the time offset must be greater than the ratio of path length along the measuring tube centerline between the corresponding sensors and the velocity of sound in the medium, or in the first component. Those skilled in the art can also use values based on experience. As soon as a time offset is less than the ratio, or less than the value based on experience, the offset can be considered not to exist as regards the detecting of a concentration fluctuation. Upon detecting a variation, which is, for example, superimposed on a sensor flow signal, usual signal processing can be applied, such as, for example, signal edge detection, signal filtering, such as, for example, Fourier transformation, or autocorrelation.

The measuring tube 10 shown in FIG. 1 includes a bend 10.4, which has a beginning region 10.41 as well as an end region 10.42. The bend can lead to a centrifugal force related shifting between the first component and the second component. Such a moving can lead to a characteristic change of the variation of the second function of time, or third function of time, compared with the variation of the first function of time. For example, a gaseous second component in a liquid first component can move toward the inside of the bend. By arranging the first sensor 11.1 in the beginning region of the bend or before the bend and arranging the second sensor 11.2 in the far region of the bend or after the bend, the characteristic change of the variation can be measured and evaluated. In this way, for example, information concerning the viscosity of the first component or concerning a ratio, Stokes number to viscosity of the first component, can be gained.

The invention is not limited to a Coriolis measuring device with one measuring tube, but is also applicable for Coriolis measuring devices with any number of measuring tubes, such as, for example, two measuring tubes or four measuring tubes, which four measuring tubes can, for example, be arranged pairwise. The invention is also not limited to measuring tubes with a bend. Those skilled in the art can also apply the invention for a Coriolis measuring device having at least one straight measuring tube.

FIG. 2 shows in simplified manner two pairs of functions of time of oscillation characteristics of the measuring tube registered by different sensors 11, wherein in the case of the upper pair a large time offset between variations V occurs in the case of a local concentration fluctuation or incidence fluctuation of a second component K2 of the medium, wherein the time offset can be used for calculating the forward motion velocity. In the case of the lower pair, only a small time offset is present. Thus, of concern here is not a local concentration fluctuation or incidence fluctuation of a second component. Rather, a flow change can be responsible for the variation. The functions of time shown in FIG. 2 can be functions of time of oscillation characteristics registered by sensors or functions of time of differences of oscillation characteristics registered by sensors.

Usually, an oscillation sensor of a Coriolis measuring device includes a permanent magnet apparatus and a coil apparatus, which are moved relative to one another by the oscillations, whereby there is induced in the coil a measurable electrical voltage, thus, an electrical voltage evaluatable by an electronic measuring/operating circuit 77, see FIG. 4. For example, the oscillation characteristic can be a phase of an oscillation sensor or a phase difference between two oscillation sensors.

In order that a time offset of the variations as caused by a concentration fluctuation be detected, the time offset must be greater than the ratio of path length along the measuring tube centerline between the corresponding sensors and the velocity of sound in the medium, or the first component. Those skilled in the art can, in such case, also use values based on experience. As soon as a time offset is lower than the ratio, or the empirical value, the offset can be considered to be nonexistent as regards the detecting of a concentration fluctuation. Upon detecting a variation, which is, for example, superimposed on a sensor flow signal, usual signal processing, such as, for example, signal edge detection, signal filtering, such as, for example, Fourier transformation, or autocorrelation, can be used.

FIG. 3 shows a method 100 of the invention, in the case of which in a first method step 101 a shifting of the local concentration fluctuation or incidence fluctuation is registered by means of the at least two sensors.

In a second method step 102, a velocity of the second component is calculated based on the registered shifting of the local concentration fluctuation or incidence fluctuation.

In a third method step 103, a velocity of the first component is ascertained from the velocity of the second component,

wherein for ascertaining the velocity of the first component at least one of the following variables is taken into consideration:

angle of inclination of the at least one measuring tube relative to the force of gravity,

viscosity of the first component,

mass density of the first component and/or of the second component.

FIG. 4 shows, by way of example, a Coriolis measuring device 1 of the invention, which has two measuring tubes 10, each of which has an inlet 10.1 and an outlet 10.2. Three sensors 11.1, 11.2 and 11.3 are adapted to register measuring tube oscillations produced by the exciter. The Coriolis measuring device includes an electronic measuring/operating circuit 77, which is adapted to operate the exciter as well as the sensors and to determine to output mass flow-, or flow velocity-, or density measurement values and wherein the measuring device has an electronics housing 80 for housing the electronic measuring/operating circuit. The measuring device includes at the inlet 10.1 as well as at the outlet 10.2 of the two measuring tubes, in each case, a securement apparatus 20. The securement apparatuses 20 are adapted to define the positions of outer oscillatory nodes of the measuring tube oscillation. Alternatively, the measuring device can have, for example, also only one measuring tube and, in another case, even four measuring tubes. The invention is not limited to any particular number of measuring tubes. The invention can also be applied in the case of a straight measuring tube.

### LIST OF REFERENCE CHARACTERS

1 Coriolis measuring device

10 measuring tube

10.1 inlet

10.2 outlet

10.3 measuring tube centerline

10.4 bend

10.41 beginning region of the bend

10.42 end region of the bend

11 sensor

11.1 first sensor

11.2 second sensor

11.3 third sensor

12 exciter

20 securement apparatus

21 plate

77 electronic measuring/operating circuit

80 housing

100 method

101 first method step

102 second method step

103 third method step

K1 first component

K2 second component

V variation

1-12. (canceled)

13. A method for operating a Coriolis measuring device for measuring mass flow or flow velocity of a medium flowing through at least one measuring tube containing at least two non-mixable components, including:
wherein each measuring tube has an inlet and an outlet,
wherein at least two sensors register measuring tube oscillations excited by at least one exciter,
wherein the sensors are arranged one after another along a measuring tube centerline, wherein a first sensor registers at least a first, inlet side, oscillation characteristic of the measuring tube oscillation at a first sensor position, and wherein a second sensor registers at least a second, outlet side, oscillation characteristic of the measuring tube oscillation at a second sensor position,
wherein a local concentration fluctuation or incidence fluctuation of at least one additional component, thus, firstly, a second component, influences the measuring tube oscillation in a region of the local concentration fluctuation or incidence fluctuation,
wherein the influencing leads to a variation of an amplitude or a phase or an oscillation frequency of the measuring tube oscillation,
wherein the method includes steps of:
registering a shifting of the local concentration fluctuation or incidence fluctuation using the at least two sensors; and
calculating a velocity of the second component based on the registered shifting of the local concentration fluctuation or incidence fluctuation.

14. The method of claim 13,
wherein a function of time of the oscillation characteristic registered by the first sensor is compared with a second function of time of the oscillation characteristic registered by the second sensor,
wherein a time offset occurrence of a variation of the first function of time relative to a variation of the second function of time is taken to mean the presence of a local concentration fluctuation or incidence fluctuation of the second component,
wherein the velocity of the second component is calculated based on the time offset of the occurrence of the variations.

15. The method of claim 14,
wherein a third sensor registers an oscillation characteristic of the measuring tube oscillation at a third sensor position, wherein the third sensor position is located between the first sensor position and the second sensor position,
wherein at least two of the following functions of time are compared:
the first function of time, the second function of time, and a third function of time,
wherein time offset occurrence of a variation of a function of time relative to a variation of another function of time indicates the presence of a local concentration fluctuation or incidence fluctuation of the second component,
wherein the velocity of the second component is calculated based on the time offset of the occurrence of the variations, or
wherein a first difference between the first function of time and the third function of time and a second difference between the third function of time and the second function of time are formed,
wherein time offset variation of a fourth function of time of the first difference relative to a variation of a fifth function of time of the second difference indicates the presence of a local concentration fluctuation or incidence fluctuation of the second component,
wherein the velocity of the second component is calculated based on the time offset of the occurrence of the variations of the differences.

16. The method of claim 13,
wherein a comparison of the functions of time and ascertaining the time offset of variations are based on at least one of the following:
forming a cross correlation of the functions of time, and
ascertaining a position of at least one extreme value of the variations.

17. The method of claim 13,
wherein the at least one measuring tube is at least sectionally bent in the resting state, wherein the first sensor position in the flow direction is before the bend or in a beginning region of the bend, and wherein the second sensor position in the flow direction is after the bend or in an end region of the bend,
wherein at least one difference between variations of different functions of time is used to determine at least one property of at least a second component,
wherein at least one of the following properties of the variations is considered:
amplitude, width, and asymmetry.

18. The method of claim 13,
wherein the first component is liquid, wherein the second component is liquid, solid or gaseous.

19. The method of claim 13,
wherein the first component is a mixture of mixable substances, or
wherein the second component is a mixture of mixable substances.

20. The method of claim 13,
wherein in a third method step a velocity of the first component is ascertained from the velocity of the second component,
wherein at least one of the following variables is used for ascertaining the velocity of the first component:
angle of inclination of the at least one measuring tube relative to the force of gravity, viscosity of the first component,
mass density of the first component or the second component,
Stokes number, and
characteristic diameter.

21. The method of claim 20,
wherein a mass flow of the medium is determined using a mass density as well as the velocity of the first component or a mass density of the second component as well as the velocity of the second component.

22. A Coriolis measuring device, including:
at least one measuring tube for conveying a medium, wherein each measuring tube has an inlet and an outlet;
at least one exciter, which is adapted to excite the measuring tube to execute oscillations;
at least two sensors, which are adapted to register the oscillations of the measuring tube;
an electronic measuring/operating circuit, which is adapted to operate the exciter as well as the sensors and to determine and to output mass flow-, or flow velocity-, or density measurement values;
wherein the measuring device includes an electronics housing for housing the electronic measuring/operating circuit; and
wherein the sensors are arranged one after another along a measuring tube centerline, wherein a first sensor registers at least a first, inlet side, oscillation characteristic of the measuring tube oscillation at a first sensor position, and wherein a second sensor registers at least a second, outlet side, oscillation characteristic of the measuring tube oscillation at a second sensor position,
wherein a local concentration fluctuation or incidence fluctuation of at least one additional component, thus, firstly, a second component, influences the measuring tube oscillation in a region of the local concentration fluctuation or incidence fluctuation,
wherein the influencing leads to a variation of an amplitude or a phase or an oscillation frequency of the measuring tube oscillation,
wherein the measuring device is configured to perform the following method:
registering a shifting of the local concentration fluctuation or incidence fluctuation using the at least two sensors; and
calculating a velocity of the second component based on the registered shifting of the local concentration fluctuation or incidence fluctuation.

23. Coriolis measuring device as claimed in claim 22,
wherein the measuring device includes at the inlet (10.1) as well as at the outlet (10.2) of the at least one measuring tube, in each case, a securement apparatus (20), which is adapted, in each case, to define the position of an outer oscillatory node,
wherein the securement apparatus includes, for example, at least one plate (21), which plate at least partially surrounds at least one measuring tube.

24. Coriolis measuring device as claimed in claim 22,
wherein the at least one measuring tube is at least sectionally bent in the resting state,
wherein the first sensor position is in the flow direction before the bend (10.4) or in a beginning region (10.41) of the bend, and wherein the second sensor position is in the flow direction after the bend or in an end region (10.42) of the bend.
